(19) United States
(12) Patent Application Publication
(10) Pub. No.: US 2013/0062800 A1
(43) Pub. Date: Mar. 14, 2013

(54) Method for Producing Wafer Lens

(71) Applicant: Keiji Arai, Kodaira-shi (JP)

(72) Inventor: Keiji Arai, Kodaira-shi (JP)

(21) Appl. No.: 13/700,423

(22) PCT Filed: Apr. 28, 2011
(86) PCT No.: PCT/JP2011/060349

§ 371 Date: Nov. 27, 2012

(30) Foreign Application Priority Data
May 27, 2010 (JP) 2010-121483

(51) Int. Cl. B29D 11/00

(52) U.S. Cl. CPC B29D 11/00326
USPC 264/1.36

(57) ABSTRACT

A method for producing a wafer lens provided with a lens portion made of a photo-curable resin on one face of a substrate. The method includes a dispensing step, a curing step and a releasing step. In the dispensing step, a photo-curable resin material is dispensed on at least one of (i) a mold having a molding surface in a shape corresponding to an optical surface shape of the lens portion and (ii) the one face of the substrate. The photo-curable resin material has a viscosity of 10000 cP or more at 25° C. In the dispensing step, the photo-curable resin material is heated so that the viscosity of the photo-curable resin material becomes between 1000 cP and 10000 cP, and dispensed.

### FIELD OF THE INVENTION

The present invention relates to a method for producing a wafer lens.

### BACKGROUND OF THE ART

Conventionally, in the field of optical lens production, there is examined a technology to provide a glass substrate with a lens portion made of a curable resin so as to obtain an optical lens having high heat resistance. (Refer to Patent Document 1, for example.) As an example of a method for producing an optical lens to which the technology is applied, there is proposed a method by which the so-called “wafer lens” provided with a plurality of optical members made of a curable resin on the surface of a glass substrate is formed, and the glass substrate is cut into pieces respectively including lens portions thereafter.

An example of a method for producing a wafer lens in a case where a photo-curable resin material is used as an energetic curable resin material, which is cured by energy being supplied thereto, is described. The resin material is dispensed into cavities of a mold by using a dispenser (a dispensing step). After that, a glass substrate attracted and fixed by a vacuum chuck is pressed on the resin material from above the mold so as to spread the resin material, and the resin material is irradiated with light so as to be cured (a curing step). After that, the glass substrate and the resin material are released from the mold (a releasing step). Consequently, a wafer lens in which a plurality of lens portions is formed on a glass substrate can be produced.

### RELATED ART DOCUMENT

### Patent Document

Patent Document 1: Japanese Patent No. 3926380

### SUMMARY OF THE INVENTION

### The Problems to be Solved by the Invention

Incidentally, there is a case where, as material of a lens portion, a photo-curable resin material having a viscosity of 10000 cP or more at a normal temperature (25° C.) is used. In particular, because a nanocomposite resin material made by inorganic particles being diffused into a photo-curable resin material reduces its linear expansion, and is excellent in increasing temperature properties of a lens and resistance to environment tests, there is a case where the nanocomposite resin material is used therefor. However, because the nanocomposite resin material is made by fine particles being diffused into resin, the viscosity thereof could be several ten thousands cP to several hundred thousands cP.

If a lens portion is molded from a photo-curable resin material having such a high viscosity, a problem arises that stringiness of the resin material, the stringiness at the time when the resin material is dispensed, is high, so that the dispensed amount of the resin material is unstable. Consequently, when the resin material is pressed and spread on a molding surface by a mold and a glass substrate, thickness of the resin material varies, and accordingly does not become uniform. As a result thereof, an error occurs in center thickness of a wafer lens, which is a cause of decrease of optical performance thereof.

The present invention is made in view of the circumstances. Objects thereof include providing a method for producing a wafer lens, the method by which stringiness of a resin material having a high viscosity, the stringiness at the time when the resin material is dispensed, is reduced, so that the dispensed amount thereof stabilizes, and the resin material can be easily spread, and can also be spread to have a uniform thickness within a short period of time, and therefore the center thickness of a wafer lens is prevented from varying, so that the wafer lens having excellent optical performance can be produced.

### Means for Solving the Problems

According to an aspect of the present invention, there is provided a method for producing a wafer lens provided with a lens portion made of a photo-curable resin on one face of a substrate, the method including:

a dispensing step to dispense a photo-curable resin material on at least one of (i) a mold having a molding surface in a shape corresponding to an optical surface shape of the lens portion and (ii) the one face of the substrate;

a curing step to press the photo-curable resin material by bringing the mold and the substrate close to each other, and irradiate the photo-curable resin material with light so as to cure the photo-curable resin material after the dispensing step; and

a releasing step to release the lens portion formed by the curing from the mold after the curing step, wherein

in the dispensing step, the photo-curable resin material is heated and dispensed.

### Advantageous Effects of the Invention

According to the present invention, stringiness of a photo-curable resin material having a high viscosity, the stringiness at the time when the resin material is dispensed, is reduced, so that the dispensed amount thereof stabilizes. Further, when the photo-curable resin material is spread on a mold or a substrate after the dispensing step, the photo-curable resin material can be easily spread, and can also be spread to have a uniform thickness within a short period of time. Therefore, the error in center thickness of a wafer lens is reduced, so that the wafer lens has excellent optical performance.

### BRIEF DESCRIPTION OF THE DRAWINGS

FIG. 1 is a perspective view schematically showing a configuration of a wafer lens.

FIG. 2 is a perspective view schematically showing configurations of a master and a sub-master.

FIG. 3A is an illustration for explaining a method for producing the wafer lens.

FIG. 3B is an illustration for explaining the method for producing the wafer lens.

FIG. 3C is an illustration for explaining the method for producing the wafer lens.

FIG. 3D is an illustration for explaining the method for producing the wafer lens.

FIG. 3E is an illustration for explaining the method for producing the wafer lens.

FIG. 4F is an illustration for explaining the method for producing the wafer lens.

FIG. 4G is an illustration for explaining the method for producing the wafer lens.

FIG. 4H is an illustration for explaining the method for producing the wafer lens.

FIG. 5A is an illustration for explaining a dispending step.

FIG. 5B is an illustration for explaining a dispending step.

FIG. 6 schematically shows configurations of a master, a sub-master, and a sub-sub-master.

FIG. 7A is an illustration for explaining a method for producing a wafer lens.

FIG. 7B is an illustration for explaining the method for producing the wafer lens.

FIG. 7C is an illustration for explaining the method for producing the wafer lens.

FIG. 7D is an illustration for explaining the method for producing the wafer lens.

FIG. 7E is an illustration for explaining the method for producing the wafer lens.

FIG. 8F is an illustration for explaining the method for producing the wafer lens.

FIG. 8G is an illustration for explaining the method for producing the wafer lens.

FIG. 8H is an illustration for explaining the method for producing the wafer lens.

FIG. 8I is an illustration for explaining the method for producing the wafer lens.

FIG. 9 is a plan view schematically showing a configuration of a large-size sub-master.

FIG. 10 is a plan view schematically showing a configuration of a normal-size sub-master.

FIG. 11 is an illustration for briefly explaining a situation in which lens portions are formed on both the front face and the back face of a glass substrate by using the large-size sub-master and the normal-size sub-master.

FIG. 12 is an illustration for explaining trouble caused by use of the large-size sub-master.

FIG. 13 shows a modification of the large-size sub-master.

### BEST MODE FOR CARRYING OUT THE INVENTION

In the following, preferred embodiments of the present invention are described referring to the drawings.

### First Embodiment

### [Wafer Lens]

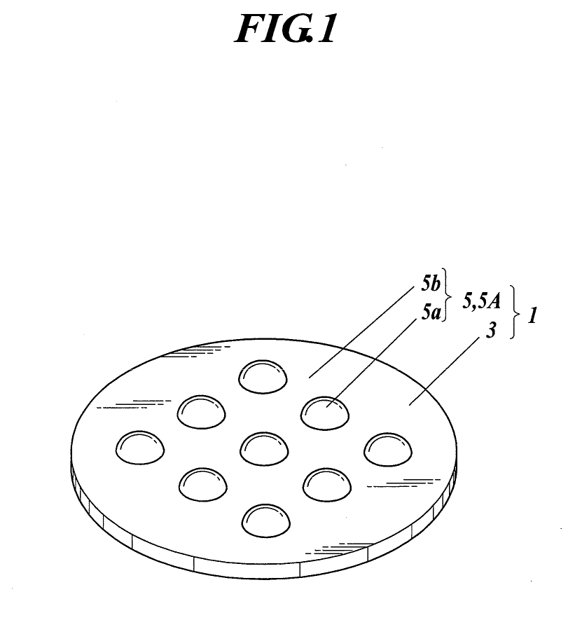

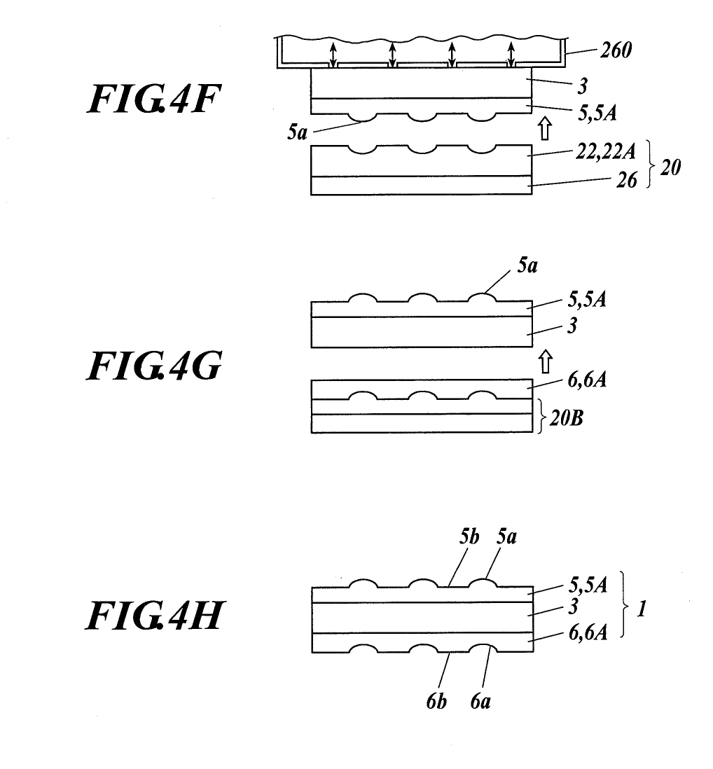

As shown in FIGS. 1 and 4H, a wafer lens 1 includes a circular glass substrate 3. On the upper face of the glass substrate 3, a resin portion 5 is formed.

Between the glass substrate 3 and the resin portion 5, a not-shown IR cut-off filter and not-shown aperture stops are formed. The resin portion 5 is made up of convex lens portions 5a and non-lens portions 5b around the convex lens portions 5a. The convex lens portions 5a and the non-lens portions 5b are integrally molded. The surfaces of the convex lens portions 5a are aspheric. The aperture stops are covered with the non-lens portions 5b.

As shown in FIG. 4H, on the lower face of the glass substrate 3, a resin portion 6 is formed.

Between the glass substrate 3 and the resin portion 6, a not-shown IR cut-off filter and not-shown aperture stops are formed. The resin portion 6 is made up of concave lens portions 6a and non-lens portions 6b around the concave lens portions 6a. The concave lens portions 6a and the non-lens portions 6b are integrally molded. The surfaces of the concave lens portions 6a are aspheric. The aperture stops are covered with the non-lens portions 6b.

The resin portions 5 and 6 are made of publically-known photo-curable resin materials 5A and 6A, respectively. Among photo-curable resin materials, photo-curable resin materials having a viscosity of 10000 cP or more at a normal temperature (25° C.) are preferable.

As the photo-curable resin materials 5A and 6A, for example, the following acrylic resins, allyl ester resins, epoxy resins or vinyl resins can be used.

If acrylic resins or allyl ester resins are used, they can be cured by radical polymerization. If epoxy resins are used, they can be cured by cationic polymerization.

Further, a nanocomposite resin material made by inorganic particles being diffused into a photo-curable resin material may be used. The average particle diameter (volume average particle diameter) of the inorganic particles is preferably 100 nm or less, and more preferably about 1 nm to 50 nm. When the average particle diameter of the inorganic particles is more than 100 nm, transmittance of an optical element could decrease because of light being scattered by the particles. Hence, 100 nm or less is preferable. When the average particle diameter of the inorganic particles is less than 1 nm, if the particles are added to the photo-curable resin material to the extent which changes optical performance or physical properties of the resin material, the specific surface area becomes very large, and the viscosity greatly increases, so that it becomes difficult to use the nanocomposite resin material. Hence, 1 nm or more is preferable.

The resin materials 5A and 6A respectively making the resin portions 5 and 6 may be the same kind or different kinds of resin.

The resin materials 6A and 6A are described in the following (1) to (4), to be more specific.

### (1) Acrylic Resin

(Meth)acrylate used for polymerization reaction is not specifically limited, and the following (meth)acrylate prepared by conventional preparation methods can be used. Examples of (meth)acrylate include ester(meth)acrylate, urethane(meth)acrylate, epoxy(meth)acrylate, ether(meth)acrylate, alkyl(meth)acrylate, alkylene(meth)acrylate, (meth)acrylate having an aromatic ring, (meth)acrylate having an alicyclic structure, and the like. These can be used solely, or in combination with two kinds or more thereof.

In particular, (meth)acrylate having an alicyclic structure is preferable, and the alicyclic structure may contain an oxygen atom or a nitrogen atom. Examples thereof include cyclohexyl(meth)acrylate, cyclopentyl(meth)acrylate, cycloheptyl(meth)acrylate, bicycloheptyl(meth)acrylate, tricyclodecyl(meth)acrylate, tricyclodecane dimethanol(meth)acrylate, isobornyl(meth)acrylate, dimethacrylate classified as hydrogenated bisphenol, and the like. Further, (meth)acrylate with an alicyclic structure having an adamantane skeleton is preferable, in particular. Examples thereof include 2-alkyl-2-adamantyl(meth)acrylate (refer to Japanese Patent Application Laid-Open Publication No. 2002-193883), adamantyl di(meth)acrylate (refer to Japanese Patent Application Laid-Open Publication No. 57-500785), adamantyl dicarboxylic acid diallyl (refer to Japanese Patent Application Laid-Open Publication No. 60-100537), perfluoroadamantyl acrylic acid ester (refer to Japanese Patent Application Laid-Open Publication No. 2004-123687), 2-methyl-2-adamantyl methacrylate produced by Shin-Nakamura Chemical Co., Ltd., 1,3-adamantane diol diacrylate, 1,3,5-adamantane triol triacrylate, unsaturated carboxylic acid adamantyl ester (refer to Japanese Patent Application Laid-Open Publication No. 2000-119220), 3,3′-dialkoxycarbonyl-1,1′biadamantane (refer to Japanese Patent Application Laid-Open Publication No. 2001-253835), 1,1′-biadamantane compound (refer to U.S. Pat. No. 3,342,880), tetra adamantane (refer to Japanese Patent Application Laid-Open Publication No. 2006-169177), 2-alkyl-2-hydroxy adamantane, 2-alkylene adamantane, a curable resin having an adamantane skeleton not including an aromatic ring such as 1,3-adamantane di-tert-butyl dicarboxylate (refer to Japanese Patent Application Laid-Open Publication No. 2001-322950), bis(hydroxyphenyl)adamantanes, bis(glycidyl oxyphenyl)adamantane (refer to Japanese Patent Application Laid-Open Publication No. 11-35522 and Japanese Patent Application Laid-Open Publication No. 10-130371), and the like.

Further, reactive monomers may be contained. Examples of (meth)acrylate include methyl acrylate, methyl methacrylate, n-butyl acrylate, n-butyl methacrylate, 2-ethyl hexyl acrylate, 2-ethyl hexyl methacrylate, isobutyl acrylate, isobutyl methacrylate, tert-butyl acrylate, tert-butyl methacrylate, phenyl acrylate, phenyl methacrylate, benzyl acrylate, benzyl methacrylate, cyclohexyl acrylate, cyclohexyl methacrylate, and the like.

As polyfunctional (meth)acrylate, the followings are included as examples: trimethylolpropane tri(meth)acrylate, pentaerythritol tetra(meth)acrylate, pentaerythritol tri(meth)acrylate, dipentaerythritol hexa(meth)acrylate, dipentaerythritol penta(meth)acrylate, dipentaerythritol tetra(meth)acrylate, dipentaerythritol tri(meth)acrylate, tripentaerythritol octa(meth)acrylate, tripentaerythritol hepta(meth)acrylate, tripentaerythritol hexa(meth)acrylate, tripentaerythritol penta(meth)acrylate, tripentaerythritol tetra(meth)acrylate, tripentaerythritol tri(meth)acrylate, and the like.

### (2) Allyl Ester Resin

Allyl ester resins are resins each having an allyl group and cured by radical polymerization. Although not specifically being limited thereto, examples thereof include the followings.

The examples thereof include bromine-containing (meth)allyl ester not including an aromatic ring (refer to Japanese Patent Application Laid-Open Publication No. 2003-66201), allyl(meth)acrylate (refer to Japanese Patent Application Laid-Open Publication No. 5-286896), an allyl ester resin (refer to Japanese Patent Application Laid-Open Publication No. 5-286896 and Japanese Patent Application Laid-Open Publication No. 2003-66201), a copolymeric compound of acrylic acid ester and an epoxy group-containing unsaturated compound (refer to Japanese Patent Application Laid-Open Publication No. 2003-128725), an acrylate compound (refer to Japanese Patent Application Laid-Open Publication No. 2003-147072), an acrylic ester compound (refer to Japanese Patent Application Laid-Open Publication No. 2005-2064), and the like.

### (3) Epoxy Resin

Epoxy resins are not specifically limited as long as they each have an epoxy group, and are cured with light or heat. Acid anhydride, a cation generating agent or the like can be used as a curing initiator. Epoxy resins are preferable because they have low cure shrinkage, and accordingly lenses can be produced at excellent molding accuracy.

Examples of epoxy resins include a novolak phenol type epoxy resin, a biphenyl type epoxy resin and a dicyclopentadiene type epoxy resin. More specifically, examples of epoxy resins include bisphenol F diglycidyl ether, bisphenol A diglycidyl ether, 2,2′-bis(4-glycidyl oxycyclohexyl)propane, 3,4-epoxycyclohexyl methyl-3,4-epoxycyclohexane carboxylate, vinylcyclohexene dioxide, 2-(3,4-epoxycyclohexyl)-5,5-spiro(3,4-epoxycyclohexane)-1,3-dioxane, bis(3,4-epoxycyclohexyl)adipate, 1,2-cyclopropane dicarboxylic acid bisglycidyl ester, and the like.

### (4) Vinyl Resin

Vinyl resins used for polymerization reaction are not specifically limited. As long as forming transparent resin composites by being cured, vinyl resins prepared by conventional preparation methods can be used.

As long as a vinyl group (CH2=CH—) contributes to cross-linking reaction, any vinyl resins can be used.

A monomer of a polyvinyl resin is expressed by a general equation CH2=CH—R. Examples thereof include polyvinyl chloride, polystyrene, and the like. In particular, aromatic vinyl resins which include aromatics in R are preferable. One vinyl group may exist in one molecule, or a plurality of vinyl groups may exist in one molecule. In particular, divinyl resins which have two or more vinyl groups are preferable. These vinyl resins can be used solely or in combination with two kinds or more thereof.

A curing agent is used to constitute a curable resin material, and not specifically limited. As the curing agent, an acid anhydride curing agent, a phenol curing agent, and the like are preferably used. Examples of the acid anhydride curing agent include phthalic anhydride, maleic anhydride, trimellitic anhydride, pyromellitic anhydride, hexahydrophthalic anhydride, 3-methyl-hexahydrophthalic anhydride, 4-methyl-hexahydrophthalic anhydride, a mixture of 3-methyl-hexahydrophthalic anhydride and 4-methyl-hexahydrophthalic anhydride, tetrahydrophthalic anhydride, nadic anhydride, methylnadic anhydride, and the like. In addition, a curing accelerator is contained as needed. The curing accelerator is not specifically limited, as long as the curing accelerator has excellent curability, is not colored, and does not spoil transparency of a curable resin. Examples of the curing accelerator include imidazoles such as 2-ethyl-4-methylimidazole (2E4MZ), tertiary amine, quarternary ammonium salt, bicyclic amidines such as diazabicycloundecen and derivatives thereof, phosphine, phosphonium salt, and the like. These can be used solely or in combination with two kinds or more thereof.

### [Method for Producing Wafer Lens]

Next, a method for producing the above-described wafer lens 1 is described in detail.

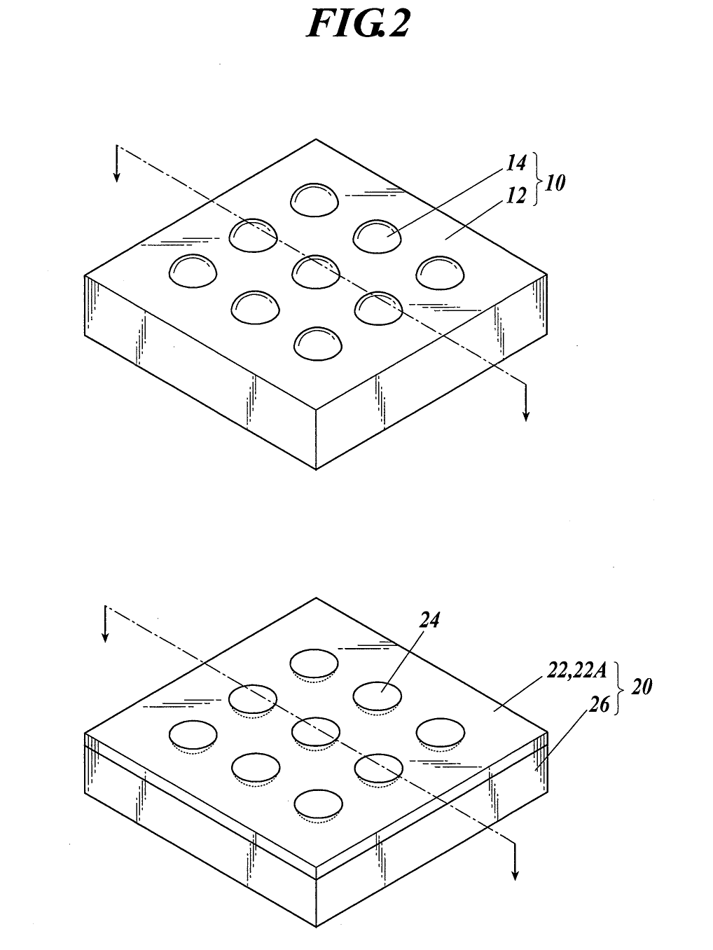

As molds to mold the wafer lens 1, a master 10 and a sub-master 20 shown in FIG. 2 are used.

### (Master)

The master 10 is configured in such a way that convex portions 14 are formed in an array on a rectangular parallelepipedic base part 12. The convex portions 14 correspond to convex lens portions 5a of the wafer lens 1, the convex portions 14 and the convex lens portions 5a being positive each other in shape. In FIG. 2, the convex portions 14 are each formed approximately in the shape of a hemisphere. The external shape of the master 10 is not necessary to be a quadrilateral, and may be a column. However, in the embodiment, the master 10 is described as a quadrilateral master.

The master 10 is made of metal, in general.

Examples of a metal material include a ferrous material, a ferroalloy, a nonferrous alloy, and the like.

Examples of the ferrous material include a hot work mold, a cold word mold, a plastic mold, a high-speed tool steel, a rolled steel for general structure, a carbon steel for machine structure, a chromium/molybdenum steel, and a stainless steel. Of these, examples of the plastic mold include a pre-hardened steel, a steel for quench and temper, and a steel for aging. Examples of the pre-hardened steel include an SC steel, an SCM steel and an SUS steel. Examples of the SC steel include PXZ. Examples of the SCM steel include HPM2, HPM7, PX5 and IMPAX. Examples of the SUS steel include HPM38, HPM77, S-STAR, G-STAR, STAVAX, RAMAX-S and PSL.

Examples of the ferroalloy are found in Japanese Patent Application Laid-Open Publication No. 2005-113161 and Japanese Patent Application Laid-Open Publication No. 2005-206913.

As examples of the nonferrous alloy, mainly, a copper alloy, an aluminum alloy, and a zinc alloy are well known. Examples thereof are also found in Japanese Patent Application Laid-Open Publication No. 10-219373 and Japanese Patent Application Laid-Open Publication No. 2000-176970, for example.

The master 10 may be made of metal glass or an amorphous alloy.

Examples of metal glass include PdCuSi, PdCuSiNi, and the like. Metal glass has excellent machinability in diamond turning, and hence a tool therefor is not worn much.

Examples of the amorphous alloy include electronic or electroless nickel phosphorus plating, and have good machinability in diamond turning.

The whole master 10 may be made of such a material having excellent machinability, or only the optical transfer surface of the master 10 may be covered with the material having excellent machinability by plating or sputtering.

### (Sub-Master)

The sub-master 20 is made up of a sub-master molding part 22 and a sub-master substrate 26. Concave portions 24 are formed in an array on the sub-master molding part 22. The concave portions 24 (a molding surface) correspond to the convex lens portions 5a of the wafer lens 1, the concave portions 24 and the convex lens portions 5a being negative each other in shape. In FIG. 2, the concave portions 24 are each depressed approximately in the shape of a hemisphere.

The sub-master molding part 22 is made of a resin material 22A.

Examples of the resin material 22A include a photo-curable resin material, and, like the resin portions 5 and 6, acrylic resins, allyl ester resins, epoxy resins, vinyl resins and the like can be used. Further, as the resin material 22A, a resin material, especially a transparent resin material, having excellent releasability is preferable. That is, a resin material which can be released from a mold without application of a mold release agent is preferable.

The sub-master substrate 26 is made of a material having smoothness, such as quartz, a silicon wafer, metal, glass and resin.

In terms of transparency (so that light irradiation can be performed from above and under the sub-master 20), it is preferable that the sub-master substrate 26 is made of quartz, glass or the like.

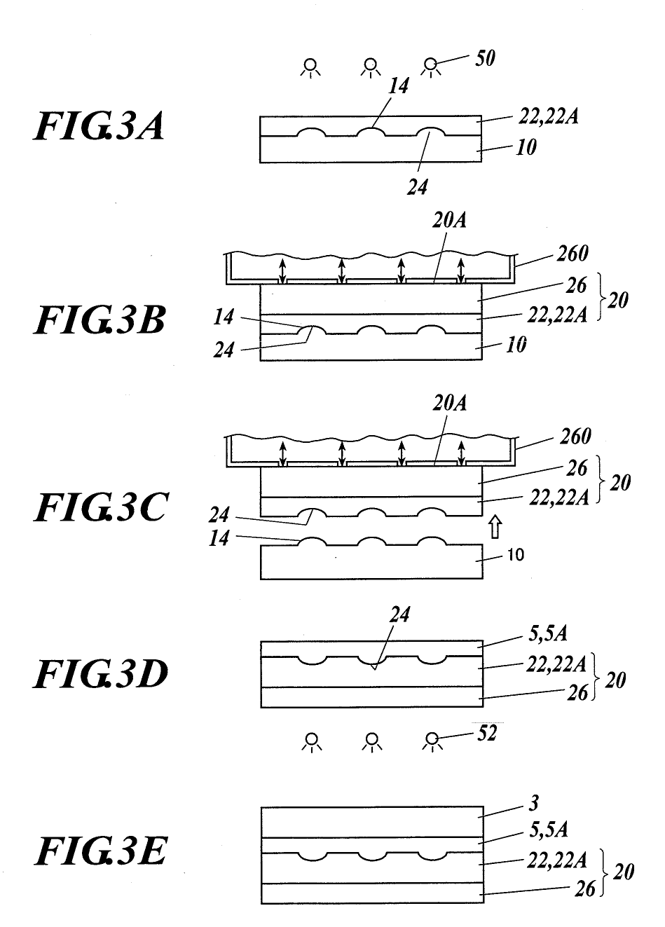

Next, the method for producing the wafer lens 1 is described referring to FIGS. 3 to 5.

As shown in FIG. 3A, the resin material 22A is dispensed on the master 10. The resin material 22A may be dispensed while vacuum drawing is performed. By dispensing the resin material 22A while performing vacuum drawing, the resin material 22A can be cured without air bubbles being mixed therein.

The resin material 22A is irradiated with light so as to be cured, and the convex portions 14 of the master 10 are transferred to the resin material 22A so that concave portions 24 are formed on the resin material 22A. Thus the sub-master molding part 22 is formed.

Examples of a light source 50 used for light irradiation include a high pressure mercury lamp, a metal halide lamp, a xenon lamp, a halogen lamp, a fluorescent lamp, a black light, a G lamp, an F lamp and the like. Either a linear light source or a point light source can be used. The high pressure mercury lamp has narrow spectrums at 365 nm and 436 nm. The metal halide lamp is a type of mercury lamp, and its output in the ultraviolet part is several times higher than that of the high pressure mercury lamp. Among the lamps, the xenon lamp has the closest spectrums to those of sunlight. The halogen lamp contains many long-wavelength rays of light, and almost all the light is near infrared light. The fluorescent lamp has an irradiation intensity to emit three primary colors of light evenly. The black light has a peak at 351 nm, and emits near ultraviolet light of 300 nm to 400 nm.

If light irradiation is performed by the light source 50, a plurality of linear or point light sources 50 may be arranged in a grid-like pattern so that light reaches the whole surface of the resin material 22A at once. Alternatively, the surface of the resin material 22A may be scanned with a linear or point light source 50 parallel so that light reaches the resin material 22A part by part. In these cases, it is preferabe that brightness distribution and illuminance (intensity) distribution during light irradiation are measured, and the number of times that light irradiation is performed, the amount of light irradiation, a duration of light irradiation, and the like are controlled on the basis of the measurement result.

After the resin material 22A is photo-cured (after the sub-master 20 is produced), post-curing (heating) may be performed on the sub-master 20. Post-curing allows the resin material 22A of the sub-master 20 to be completely cured, so that a mold life of the sub-master 20 can be prolonged.

As shown in FIG. 3B, the sub-master substrate 26 is made to adhere to the sub-master molding part 22. To enhance adhesion between the sub-master molding part 22 and sub-master substrate 26, a saline coupling agent may be applied to the sub-master substrate 26, for example.

If, as described above, the sub-master substrate 26 is mounted on the sub-master molding part 22 after the convex portions 14 of the master 10 are transferred to the resin material 22A and the resin material 22A is cured (that is, after the sub-master molding part 22 is formed), an adhesive is used.

Conversely, the sub-master substrate 26 may be mounted on the sub-master molding part 22 after the convex portions 14 of the master 10 are transferred to the resin material 22A but before the resin material 22A is cured. In this case, without using an adhesive, the sub-master substrate 26 is made to stick to the resin material 22A by adhesion of the resin material 22A, or the sub master substrate 26 is made to adhere to the resin material 22A by application of a coupling agent to the sub-master substrate 26 so that adhesion is enhanced. As a method for curing the resin material 22A while backing the resin material 22A with the sub-master substrate 26, there is a method which uses a UV curable resin as the resin material 22A and a UV transmittable substrate as the sub-master substrate 26, and irradiates the resin material 22A with UV light from the sub-master substrate 26 side in a state in which the resin material 22A is filled between the master 10 and the sub-master substrate 26.

In order to back the sub-master molding part 22 (resin material 22A) with the sub-master substrate 26, it is preferable to use a publically-known vacuum chunk 260, and back the sub-master molding part 22 with the sub-master substrate 26 while attracting the sub-master substrate 26 to an attracting surface 260A of the vacuum chuck 260 so as to hold the sub-master substrate 26, and making the attracting surface 260A parallel to a molding surface for the convex portions 14 in the master 10.

After that, as shown in FIG. 3C, the sub-master molding part 22 and the sub-master substrate 26 are released from the master 10. Thus the sub-master 20 is produced.

After that, as shown in FIG. 3D, the resin material 5A is dispensed on the sub-master 20 (a dispensing step). At the time, the resin material 5A is dispensed while a dispenser is heated so that the viscosity of the resin material 5A to be dispensed becomes between 1000 cP and 10000 cP. The resin material 5A to be used is a photo-curable resin material having a viscosity of 10000 cP or more at a normal temperature (25° C.). In particular, if a nanocomposite resin material is dispensed, it is preferable to decrease the viscosity thereof by continuously heating the dispenser so as to perform molding. Further, it is preferable to heat the sub-master 20 too so as to become substantially the same temperature as that of the resin material 5A. By dispensing the resin material 5A while heating the resin material 5A so as to become the above-described viscosity, stringiness of the resin material 5A is reduced, so that the dispensed amount of the resin material 5A stabilizes.

As to a method for measuring the viscosity, the viscosity can be measured by using a vibration type viscometer.

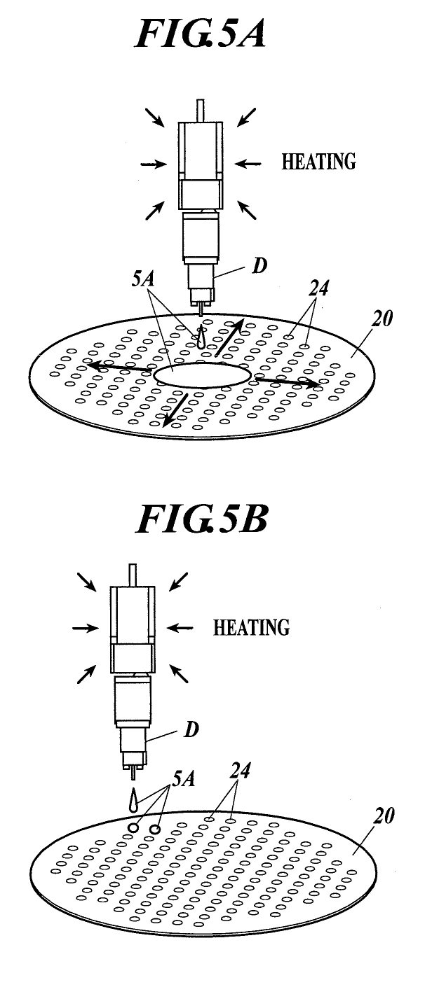

As a dispensing method, center dropping shown in FIG. 5A or individual dropping shown in FIG. 5B may be performed. In center dropping, all the resin material 5A is dispensed by a dispenser D. That is, a photo-curable resin material is disposed at the center of the sub-master 20 so as to be dispensed in such a way as to spread over the concave portions 24 of the sub-master 20. In individual dropping, the resin material 5A is dispensed on the concave portions 24 of the sub-master 20 individually. That is, a photo-curable resin material is dispensed on the concave portions 24 of the sub-master 20 one by one.

The number of concave portions 24 of the sub-master 20 and the shape of the sub-master 20 shown in FIG. 5 are different from those in FIG. 2 for convenience of illustration, but they are the same in practical use.

When the resin material 22A is dispensed on the master 10 too, the resin material 22A may be dispensed while a dispenser is heated so that the viscosity of the resin material 22A becomes between 1000 cP and 10000 cP. It is preferable that the resin material 22A to be dispensed is a photo-curable resin material having a viscosity of 10000 cP or more at a normal temperature (25° C.). Further, it is preferable to heat the master 10 too so as to become substantially the same temperature as that of the resin material 22A.

Further, the resin material 5A may be dispensed while vacuum drawing is performed.

Then, as shown in FIG. 3E, the resin material 5A is cured while the glass substrate 3 is pressed on the resin material 5A from above so as to spread the resin material 5A (a curing step). It is preferable to heat the glass substrate 3 and the sub-master 20 so as to become substantially the same temperature as that of the resin material 5A, which is heated while being dispensed, when pressing the resin material 5A with the glass substrate 3 so as to spread the resin material 5A. By heating the glass substrate 3 and the sub-master 20 so as to become substantially the same temperature as that of the resin material 5A, the viscosity of the resin material 5A can be kept at 10000 cP or less while the resin material 5A is spread too. Accordingly, the resin material 5A can be easily spread, and can also be spread to have a uniform thickness within a short period of time.

If, like the embodiment, a resin layer of a wafer lens includes a lens portion and a flat portion around the lens portion, a pressing force between a mold and a substrate against each other during molding tends to be high. However, by heating the resin material as described above, molding can be easily performed. In the embodiment, the glass substrate 3 is pressed onto the sub-master 20. However, instead of that, the sub-master 20 may be pressed onto the glass substrate 3 with the resin material between the sub-master 20 and the glass substrate 3. Alternatively, both the glass substrate 3 and the sub-master 20 may be brought close to each other. In short, it is just necessary that the resin material is pressed by the sub-master 20 and the glass substrate 3 being brought close to each other.

To cure the resin material 5A, light irradiation may be performed by a light source 52, which is disposed above the glass substrate 3, from the glass substrate 3 side, may be performed by a light source (not shown), which is disposed under the sub-master 20, from the sub-master 20 side, or may be performed from by both of the light sources from the glass substrate 3 side and the sub-master 20 side. As the light source 52, a light source which is the same as the light source used as the light source 50 can be used.

As shown in FIG. 4F, the resin portion 5 and the glass substrate 3 are released from the sub-master 20 (a releasing step). Thus the convex lens portions 5a are formed on one face of the glass substrate 3.

Next, a method for forming the concave lens portions 6a on the other face of the glass substrate 3 is described.

In this case, a master (not shown) having a molding surface corresponding to the concave lens portions 6a is prepared, the molding surface and the concave lens portions 6a being positive each other in shape, and a sub-master 20B having a molding surface corresponding to the concave lens portions 6a is formed by using the master, the molding surface and the concave lens portions 6a being negative each other in shape. Then, as shown in FIG. 4G, in a similar manner to that described referring to FIG. 3D, the resin material 6A is dispensed on the sub-master 20B having the molding surface corresponding to the concave lens portions 6a, the molding surface and the concave lens portions 6a being negative each other in shape. That is, the resin material 6A is dispensed while a dispenser is heated so that the viscosity of the resin material 6A to be dispensed becomes between 1000 cP and 10000 cP. After the resin material 6A is dispensed on the sub-master 20B, the sub-master 20B is made to abut the glass substrate 3 formed with the resin portion 5 as shown in FIG. 4F, the glass substrate 3 with the resin portion 5 being turned upside down, so that the resin material 6A is filled between the glass substrate 3 and the sub-master 20B. After that, the resin material 6A is irradiated with light so as to be cured.

Lastly, the glass substrate 3 and the resin portion 6 are released from the sub-master 20B. Thus, as shown in FIG. 4H, the wafer lens 1 including the glass substrate 3 having the convex lens portions 5a and the concave lens portions 6a is produced.

In the above method, the resin materials 5A and 6A are dispensed on the faces of the glass substrate 3, respectively, and cured. However, it is possible that the glass substrate 3 with the resin portion 5 is turned upside down before the resin material 5A is completely cured in the state shown in FIG. 3E, the glass substrate 3 is made to abut the resin material 6A dispensed on the sub-master 20B shown in FIG. 4G, and then the resin materials 5A and 6A are cured at the same time by light irradiation from above the sub-master 20 and under the sub-master 20B.

Further, it is possible that after the glass substrate 3 and the resin portion 5 are released from the sub-master 20 as shown in FIG. 4F, without turning the glass substrate 3 with the resin portion 5 upside down, the resin material 6A is applied to the other face of the glass substrate 3, the sub-master 20B is pressed on the resin material 6A from above, and then the resin materials 5A and 6A are cured at the same time by light irradiation from above the sub-master 20 and under the sub-master 20B.

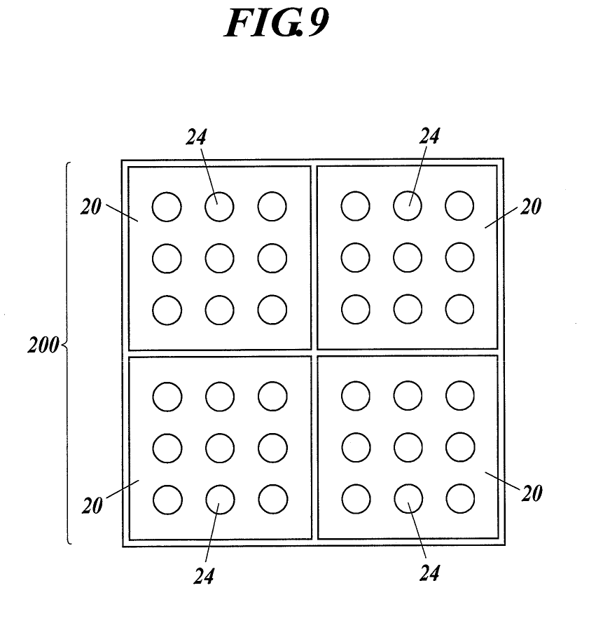

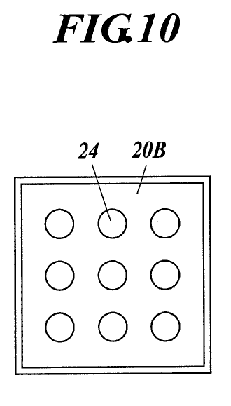

In the case where the resin portions 5 are respectively formed on the front face and the back face of the glass substrate 3, it is possible that a many-in-one type large-size sub-master 200, shown in FIG. 9, having the length and the width being twice (the magnification can be changed) the length and the width of the sub-master 20 and the normal-size sub-master 20B shown in FIG. 10 are prepared, the sub-master 200 is used to form the resin portion 5 on the front face of the glass substrate 3, and the sub-master 20B is used multiple times to form the resin portion 6 on the other face, namely, the back face, of the glass substrate 3.

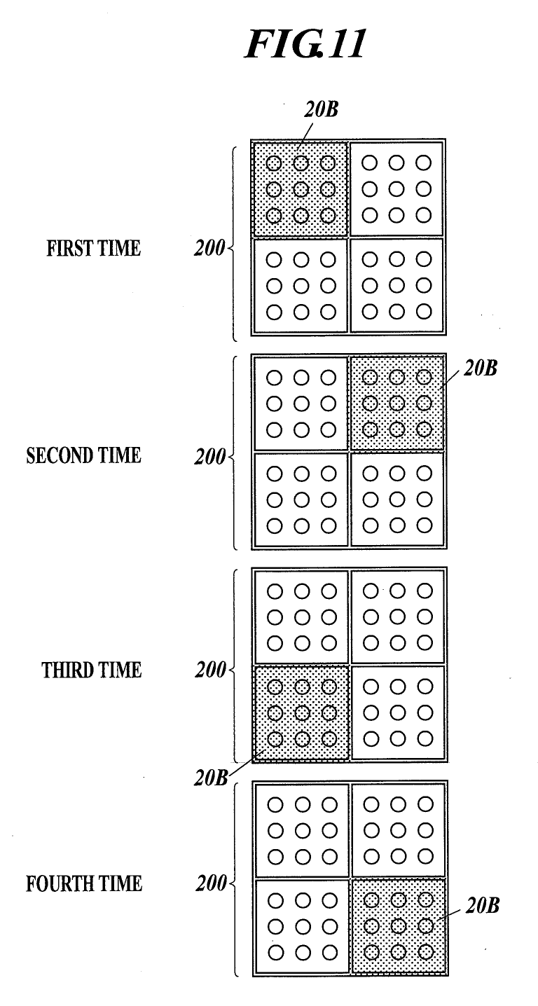

More specifically, for the front face of the glass substrate 3, the large-size sub-master 200 is used one time so as to form the resin portion 5 thereon, and for the back face of the glass substrate 3, as shown in FIG. 11, the sub-master 20B is used four times so as to form the resin portion 6 thereon by moving the sub-master 20B a quarter of the large-size sub-master 200 each time. Accordingly, it is easy to align the sub-master 20B with the glass substrate 3 having the resin portion 5 formed by using the large-size sub-master 200, so that a situation can be prevented from occurring, the situation in which an arrangement in the resin portion 5 formed on the front face of the glass substrate 3 by using the large-size sub-master 200 do not match an arrangement in the resin portion 5 formed on the back face of the glass substrate 3 by using the sub-master 20B.

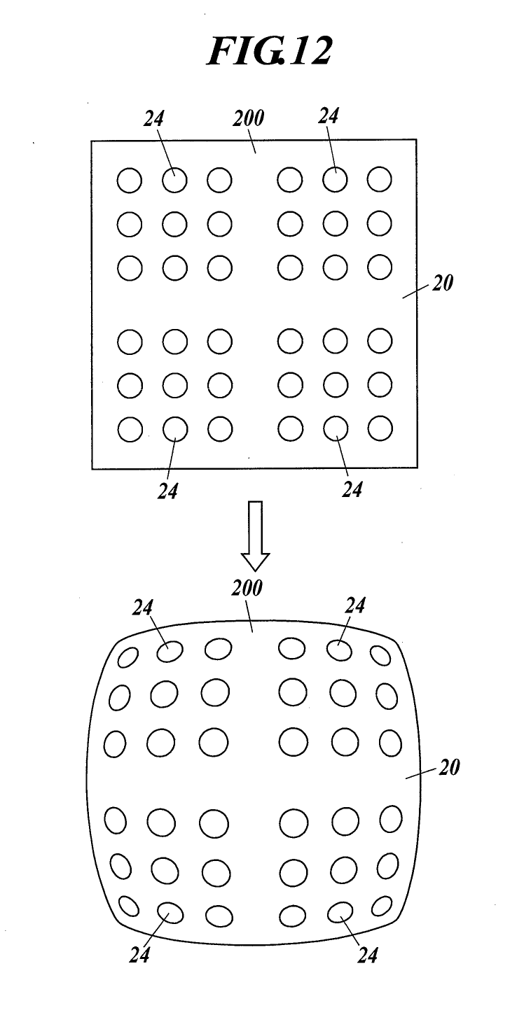

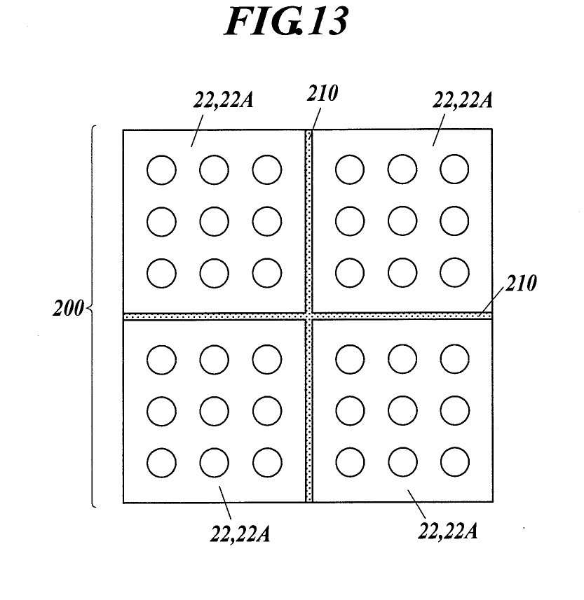

However, in the case where the large-size sub-master 200 is used, as shown in FIG. 12, the sub-master molding part 22 thereof could warp a little, so that the large-size sub-master 200 could not perform its original function as a mold. Hence, as shown in FIG. 13, it is preferable to configure the large-size sub-master 200 so as to prevent the sub-master molding part 22 of the large-size sub-master 200 from warping (namely, to relieve stress between the large-size sub-master 200 and the glass substrate 3) by providing the large-size sub-master 200 with a cross-shaped region (a stress relaxation portion 210) at the center of the large-size sub-master 200. The cross-shaped region is a region where the resin material 22A does not exist, and divides the large-size sub-master 200 into a plurality of areas.

In the case where the large-size sub-master 200 is provided with the stress relaxation portion 210, for example, if the resin material 22A is a photo-curable resin material, a non-irradiated portion which is not irradiated with light may be formed by masking the glass substrate 3 or the sub-master substrate 26, or by masking the light source 52 or 54.

In the embodiment, the sub-master 20 is produced by using the master 10, and the resin portion 5 is molded by using the sub-master 20. However, the resin portion 5 may be molded by using a master (not shown) directly. In this case, the master to be used has concave portions corresponding to the convex lens portions 5a, the concave portions and the convex lens portions 5a being negative each other in shape. Then, in a similar manner to that described referring to FIG. 3D, the resin material 5A is dispensed on the concave portions of the master, the resin material 5A is cured while the glass substrate 3 is pressed on the resin material 5A from above, and then the glass substrate 3 and the resin portion 5 are released from the master.

Similarly, the resin portion 6 may also be molded by a master (not shown) having convex portions corresponding to the concave lens portions 6a directly, the convex portions and the concave lens portions 6a being negative each other in shape.

### Second Embodiment

The second embodiment is different from the first embodiment mainly in the following points, and almost the same as the first embodiment in the other points.

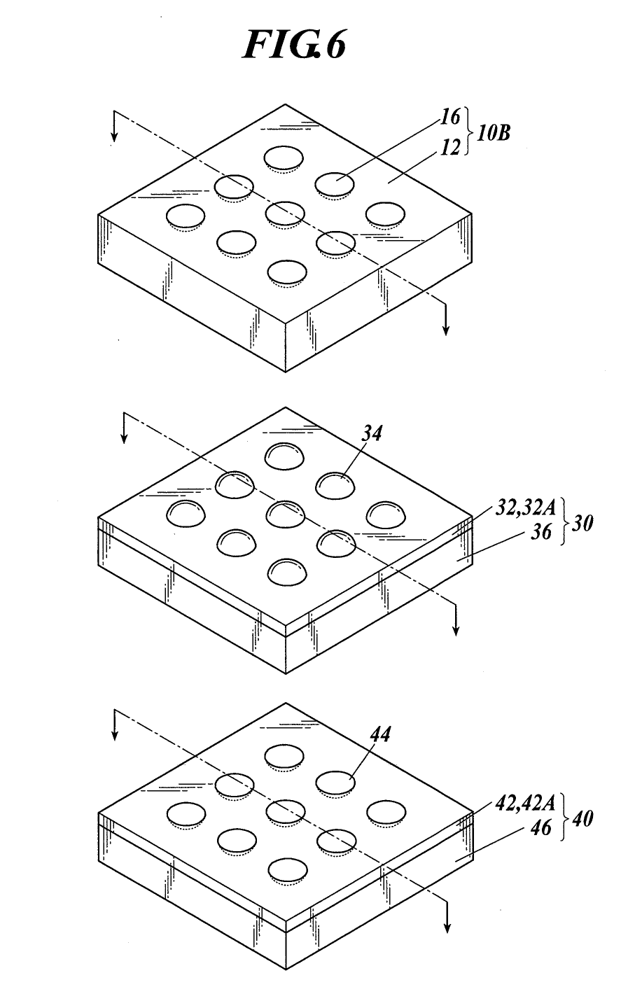

To produce the wafer lens 1, a master 10B, a sub-master 30, and a sub-sub-master 40 shown in FIG. 6 are used as molds. While the sub-master 20 is used to produce the wafer lens 1 by using the master 10 first in the first embodiment, two molds, the sub-master 30 and the sub-sub-master 40, are used to produce the wafer lens 1 by using the master 10B first, which is a main different point between the first embodiment and the second embodiment. In particular, it is different from the first embodiment that the sub-sub-master 40 is produced by using the sub-master 30, while a procedure for producing the sub-master 30 by using the master 10B and a procedure for producing the wafer lens 1 by using the sub-sub-master 40 are almost the same as those described in the first embodiment.

### (Master)

The master 10B is configured in such a way that concave portions 16 are formed in an array on the rectangular parallelepipedic base part 12. The concave portions 16 correspond to the convex lens portions 5a of the wafer lens 1, the concave portions 16 and the convex lens portions 5a being negative each other in shape. In FIG. 6, the concave portions 16 are each depressed approximately in the shape of a hemisphere. The external shape of the master 10B is not necessary to be a quadrilateral, and may be a column. However, in the embodiment, the master 10B is described as a quadrilateral master.

Material and the like of the master 10B are the same as those of the master 10 described above.

### (Sub-Master)

The sub-master 30 is made up of a sub-master molding part 32 and a sub-master substrate 36. Convex portions 34 are formed in an array on the sub-master molding part 32. The convex portions 34 (a molding surface) correspond to the convex lens portions 5a of the wafer lens 1, the convex portions 34 and the convex lens portions 5a being positive each other in shape. In FIG. 6, the convex portions 34 are each formed approximately in the shape of a hemisphere.

The sub-master molding part 32 is made of a resin material 32A. As the resin material 32A, the material used for the sub-master 20 in the first embodiment can be used.

As material of the sub-master substrate 36, material which is the same as the material of the sub-master substrate 26 can be used.

### (Sub-Sub-Master)

The sub-sub-master 40 is made up of a sub-sub-master molding part 42 and a sub-sub-master substrate 46.

Concave portions 44 are formed in an array on the sub-sub-master molding part 42. The concave portions 44 (a molding surface) correspond to the convex lens portions 5a of the wafer lens 1, the concave portions 44 and the convex lens portions 5a being negative each other in shape. In FIG. 6, the concave portions 44 are each depressed approximately in the shape of a hemisphere.

The sub-sub-master molding part 42 is made of a resin material 42A which is the same as the resin material 32A of the sub-master molding part 32. The sub-sub-master substrate 46 is made of material which is the same as the material of the sub-master substrate 36.

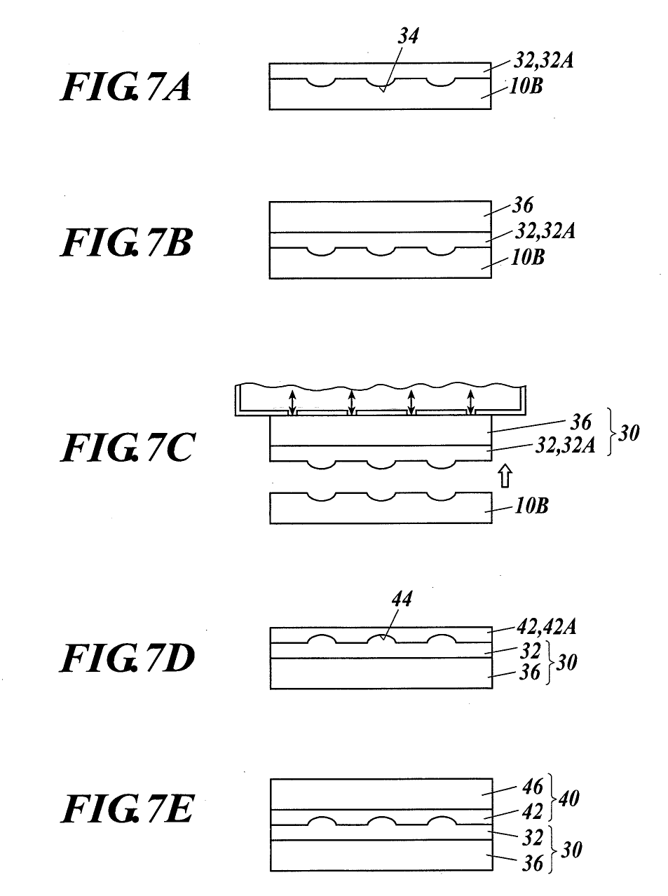

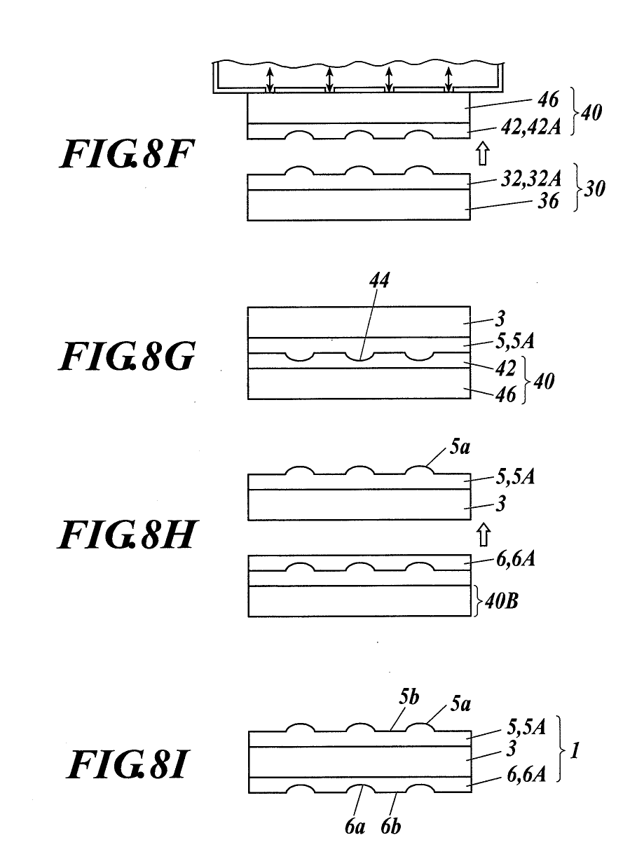

Next, a method for producing the wafer lens 1 is briefly described referring to FIGS. 7 and 8.

As shown in FIG. 7A, the resin material 32A is dispensed on the master 10B. Then, the rein material 32A is irradiated with light so as to be cured, and the concave portions 16 of the master 10B are transferred to the resin material 32A so that the convex portions 34 are formed on the resin material 32A. Thus the sub-master molding part 32 is formed.

As shown in FIG. 7B, the sub-master substrate 36 is made to adhere to the sub-master molding part 32.

After that, as shown in FIG. 7C, the sub-master molding part 32 and the sub-master substrate 36 are released from the master 10B. Thus the sub-master 30 is produced.

After that, as shown in FIG. 7D, the resin material 42A is dispensed on the sub-master 30. Then, the resin material 42A is irradiated with light so as to be cured, and the convex portions 34 of the sub-master 30 are transferred to the resin material 42A so that the concave portions 44 are formed on the resin material 42A. Thus the sub-sub-master molding part 42 is formed.

After that, as shown in FIG. 7E, the sub-sub-master substrate 46 is made to adhere to the sub-sub-master molding part 42.

As shown in FIG. 8F, the sub-sub-master molding part 42 and the sub-sub-master substrate 46 are released from the sub-master 30. Thus the sub-sub-master 40 is produced.

As shown in FIG. 8G, the resin material 5A is dispensed on the sub-sub-master 40 (a dispensing step). At the time, the resin material 5A is dispensed while a dispenser is heated so that the viscosity of the resin material 5A becomes between 1000 cP and 10000 cP. The resin material 5A to be used is a photo-curable resin material having a viscosity of 10000 cP or more at a normal temperature (25° C.). Further, it is preferable to heat the sub-sub-master 40 too so as to become substantially the same temperature as that of the resin material 5A. As a dispensing method, center dropping (shown in FIG. 5A) or individual dropping (shown in FIG. 5B), which are described above, can be used.

When the resin material 22A is dispensed on the master 10B and/or when the resin material 42A is dispensed on the sub-master 30 too, the resin material 22A and/or 42A may be dispensed while a dispenser is heated so that the viscosity of the resin material 22A and/or 42A becomes between 1000 cP and 10000 cP. It is preferable that the resin material 22A and/or 42A to be dispensed is a photo-curable resin material having a viscosity of 10000 cP or more at a normal temperature (25° C.). Further, it is preferable to heat the master 10 and/or the sub-master 30 too so as to become substantially the same temperature as that of the resin material 22A and/or 42A.

After that, the resin material 5A is cured while the glass substrate 3 is pressed on the resin material 5A from above so as to spread the resin material 5A (a curing step). It is preferable to heat the glass substrate 3 and the sub-sub-master 40 so as to become substantially the same temperature as that of the resin material 5A, which is heated while being dispensed, when pressing the resin material 5A with the glass substrate 3 so as to spread the resin material 5A.

To cure the resin material 5, light irradiation should be performed by a not-shown light source/light sources at least from one of the glass substrate 3 side and the sub-sub-master 40 side.

Consequently, the resin portion 5 is formed from the resin material 5A. After that, the resin portion 5 and the glass substrate 3 are released from the sub-sub-master 40 (a releasing step). Thus the convex lens portions 5a are formed on one face of the glass substrate 3.

Next, a method for forming the concave lens portions 6a on the other face of the glass substrate 3 is described.

In this case, a master (not shown) having a molding surface corresponding to the concave lens portions 6a is prepared, the molding surface and the concave lens portions 6a being negative each other in shape, and a sub-master (not shown) having a molding surface corresponding to the concave lens portions 6a is formed by using the master, the molding surface and the concave lens portions 6a being positive each other in shape. Further, a sub-sub-master 40B having a molding surface corresponding to the concave lens portions 6a is formed by using the sub-master, the molding surface and the concave lens portions 6a being negative each other in shape.

Then, as shown in FIG. 8H, after the resin material 6A is dispensed on the sub-sub-master 40B in a similar manner as that described referring to FIG. 8G, the sub-sub-master 40B is made to abut the glass substrate 3 formed with the resin portion 5 as shown in FIG. 8G, the glass substrate 3 with the resin portion 5 being turned upside down, so that the resin material 6A is filled between the glass substrate 3 and the sub-sub-master 40B. After that, the resin material 6A is irradiated with light so as to be cured.

Lastly, the glass substrate 3 and the resin portion 6A are released from the sub-sub-master 40B. Thus, as shown in FIG. 8I, the wafer lens 1 including the glass substrate 3 having the convex lens portions 5a and the concave lens portions 6a is produced.

After that, the wafer lens 1 is diced into pieces respectively including lens portions so as to be individual lenses.

### Example

In accordance with the following conditions and the following Table 1, wafer lenses for “Samples 1 to 16” were produced. The wafer lenses were produced in accordance with the procedure described in the second embodiment.
Substrate: 8 inches, made of glass
Sub-sub-master:
   8 inches, made of resin, having 1000 concave portions
Resin material to be dispensed:
   As a resin material having a viscosity of 15000 cP at a normal temperature (25° C.), a bisphenol A epoxy resin material including aromatic sulfonium as a polymerization initiator was used. As a resin material having a viscosity of 45000 cP at a normal temperature (25° C.), a bisphenol A epoxy resin material including aromatic sulfonium as a polymerization initiator, the bisphenol A epoxy resin material to which silica nanoparticles had been added at 20 wt %, was used.
Target value of dispensed amount of resin material: 2500 mg
Dispensing method:
   Center dropping or individual dropping

### (Viscosity Measurement)

The measurement was performed by using a vibration type viscometer. The obtained values are shown in Table 1.

### (Actual Dispensed Amount of Resin Material)

The dispensed amount of the resin material was measured. The difference (mg) from the target value of the dispensed amount is referred to as a dispensed amount error. The smaller the value of the dispensed amount error is, the lower the stringiness of the resin material is, the stringiness at the time when the resin material is dispensed, and accordingly the more stable the dispensed amount is. In particular, it is preferable that the dispensed amount error is less than 10 mg, which indicates that the dispensed amount is highly stable. The result is shown in Table 1.

### (Center Thickness Measurement)

The center thickness of each of the wafer lenses was measured by using an FB center thickness measuring device (produced by Konica Minolta Optics, Inc.). The difference (μm) from a setting value is referred to as a lens center thickness error. The smaller the value of the lens center thickness error is, the more stable the dispensed amount at the time when the resin material is dispensed is. In particular, it is preferable that the lens center thickness error is less than 10 μm, which indicates that the optical performance hardly decreases. The result is shown in Table 1.

### (Spread Time of Resin Material)

A period of time was measured, the period of time from the time when pressing was performed at 100 N by using a molding device so that all of the 1000 concave portions provided on the sub-sub-master were filled with the resin material, the concave portions in a shape corresponding to an optical surface shape of lens portions, to the time when the center thickness (thickness obtained by adding a distance from a lens apex to the substrate to thickness of the substrate) of each of the lens portions reached a setting value of 500 μm. The period of time is referred to as a spread time of the resin material. As the viscosity of the resin material decreases by heating, spreadability of the resin material by being sandwiched between a mold and a glass substrate so as to be pressed thereby increases. Accordingly, the spread time is reduced, which contributes to reduction of a takt time for producing a wafer lens.

TABLE 1

| | RESIN | | VISCOSITY | | | | |
|---|---|---|---|---|---|---|---|
| | VISCOSITY[cP] | HEATING | DURING | | DISPENSED | LENS CENTER | |
| | AT NORMAL | TEMPERATURE | HEATING | | AMOUNT | THICKNESS | SPREAD |
| SAMPLE | TEMPERATURE 25° C. | [cP] | [cP] | DISPENSING METHOD | ERROR[mg] | ERROR[um] | TIME[min] |
| 1 | 15000 | NO HEATING | 15000 | CENTER DROPPING | +13 | 15 | 23 |
| 2 | | | | INDIVIDUAL DROPPING | +15 | 16 | 7 |
| 3 | | 30 | 10500 | CENTER DROPPING | +8 | 11 | 18 |
| 4 | | | | INDIVIDUAL DROPPING | +11 | 13 | 6 |
| 5 | | 40 | 8000 | CENTER DROPPING | +5 | 7 | 13 |
| 6 | | | | INDIVIDUAL DROPPING | +7 | 8 | 3 |
| 7 | | 50 | 3000 | CENTER DROPPING | +1 | 3 | 6 |
| 8 | | | | INDIVIDUAL DROPPING | +1 | 2 | 1 |
| 9 | 45000 | NO HEATING | 45000 | CENTER DROPPING | +22 | 20 | 35 |
| 10 | | | | INDIVIDUAL DROPPING | +25 | 23 | 11 |
| 11 | | 40 | 20000 | CENTER DROPPING | +17 | 19 | 27 |
| 12 | | | | INDIVIDUAL DROPPING | +19 | 20 | 8 |
| 13 | | 50 | 11000 | CENTER DROPPING | +8 | 10 | 18 |
| 14 | | | | INDIVIDUAL DROPPING | +11 | 14 | 5 |
| 15 | | 125 | 6000 | CENTER DROPPING | +3 | 8 | 10 |
| 16 | | | | INDIVIDUAL DROPPING | +4 | 7 | 3 |

According to the results shown in Table 1, Samples 5-8 and 15-16 each having a viscosity of 10000 cP or less during heating have a smaller dispensed amount error and a smaller lens center thickness error than those of Samples 1-4 and 9-14 each having a viscosity of more than 10000 cP during heating.

### EXPLANATION OF REFERENCES

1 Wafer Lens
3 Glass Substrate
5 Resin Portion
5a Convex Lens Portion
5b Non-Lens Portion
5A Resin Material
6 Resin Portion
6a Concave Lens Portion
6b Non-Lens Portion
6A Resin Material
10, 10B Master
12 Base Part
14 Convex Portion
16 Concave Portion
20 Sub-Master
22 Sub-Master Molding Part
22A Resin Material
24 Concave Portion
25 Convex Portion
26 Sub-Master Substrate
30 Sub-Master
32 Sub-Master Molding Part
32A Resin Material
34 Convex Portion
36 Sub-Master Substrate
40 Sub-Sub-Master
42 Sub-Sub-Master Molding Part
42A Resin Material
44 Concave Portion
46 Sub-Sub-Master Substrate
50, 52 Light Source
200 Large-Size Sub-Master
210 Stress Relaxation Portion
D Dispenser

1. A method for producing a wafer lens provided with a lens portion made of a photo-curable resin on one face of a substrate, the method comprising:
a dispensing step to dispense a photo-curable resin material on at least one of (i) a mold having a molding surface in a shape corresponding to an optical surface shape of the lens portion and (ii) the one face of the substrate;
a curing step to press the photo-curable resin material by bringing the mold and the substrate close to each other, and irradiate the photo-curable resin material with light so as to cure the photo-curable resin material after the dispensing step; and
a releasing step to release the lens portion formed by the curing from the mold after the curing step, wherein
the photo-curable resin material has a viscosity of 10000 cP or more at 25° C., and
in the dispensing step, the photo-curable resin material is heated so that the viscosity of the photo-curable resin material becomes between 1000 cP and 10000 cP, and dispensed.

2. (canceled)

3. The method for producing a wafer lens according to claim 1, wherein in the dispensing step, the mold is heated.

4. The method for producing a wafer lens according to claim 1, wherein in the curing step, the photo-curable resin material is pressed by the mold and the substrate being brought close to each other while the mold and the substrate are heated.

5. The method for producing a wafer lens according to claim 1, wherein an inorganic particle is diffused into the photo-curable resin material.

6. The method for producing a wafer lens according to claim 1, wherein in the dispensing step, the heated photo-curable resin material is dispensed on at least one of the mold which is heated and the substrate which is heated.

7. The method for producing a wafer lens according to claim 6, wherein in the dispensing step, the mold is heated to become substantially the same temperature as a temperature of the heated photo-curable resin material.

8. The method for producing a wafer lens according to claim 6, wherein in the dispensing step, the substrate is heated to become substantially the same temperature as a temperature of the heated photo-curable resin material.

9. The method for producing a wafer lens according to claim 1, wherein in the dispensing step, the photo-curable resin material is dispensed on the mold.

10. The method for producing a wafer lens according to claim 1, wherein
the wafer lens is provided with a plurality of lens portions made of the photo-curable resin on the one face of the substrate, and
the mold has the molding surface including a plurality of molding portions in a shape corresponding to the optical surface shape of the lens portions.

11. The method for producing a wafer lens according to claim 10, wherein in the dispensing step, the photo-curable resin material is dispensed on positions on the substrate and/or the mold individually, the positions respectively corresponding to the molding portions.

12. The method for producing a wafer lens according to claim 10, wherein in the dispensing step, the photo-curable resin material is dispensed in such a way as to spread over positions on the substrate and/or the mold, the positions respectively corresponding to the molding portions.

13. The method for producing a wafer lens according to claim 1, wherein the wafer lens includes the lens portion and a flat portion formed around the lens portion.
